(19) United States
(12) Patent Application Publication
(10) Pub. No.: US 2026/0208442 A1
(43) Pub. Date: Jul. 23, 2026

(54) High Temperature 3D Printing Device

(71) Applicant: Ahsumethsi Sous, Santa Anna, CA (US)

(72) Inventor: Ahsumethsi Sous, Santa Anna, CA (US)

(21) Appl. No.: 19/030,437

(22) Filed: Jan. 17, 2025

(51) Int. Cl. B29C 64/314; B29C 64/118; B29C 64/209; B29C 64/295; B33Y 10/00; B33Y 30/00; B33Y 40/10

(52) U.S. Cl. CPC B29C 64/314; B29C 64/118; B29C 64/209; B29C 64/295; B33Y 10/00; B33Y 30/00; B33Y 40/10

(57) ABSTRACT

The Umbrella is the only product of its kind that offers an improved 3D printing machine that is capable of not only reaching extreme temperatures but also requires no electronic or electrical components inside the chamber; thereby, preventing overheating, as tasks are accomplished. This unprecedented device is uniquely designed with durable, high-quality materials to ensure long-term sustainability and can serve in educational, commercial and/or personal settings, to meet diverse consumer needs.

### BACKGROUND

3D printers have enjoyed a decent rise in popularity in recent years; yet, current versions of FDM (fused deposition modeling) 3D printers are only able to extrude material up to a temperature of around five hundred degrees Fahrenheit (500℉). In the industry, prolonged use at these temperatures will eventually degrade parts of the printer affecting quality and output. There have been no products available as original equipment or as an aftermarket to address this problem.

An apparatus that allows users to use 3D printers at a higher temperature providing better printed items, without degrading the printer parts and quality of output designs, is not being met by any known device or system at present. There have been no products available as original equipment or as an aftermarket to address this problem either.

### SUMMARY OF THE INVENTION

The main purpose the disclosure is to provide users with a FDM 3D Printer capable of reaching extreme temperatures to facilitate creating high-performance parts that can withstand even the toughest environments.

Also known as the ‘Umbrella,’ the disclosed 3D printing device includes a filament sieve defining a plurality of openings for filaments to enter there through and provide a barrier to an egress of filaments there through. The disclosure also includes a heating chamber attached adjacent the filament sieve and configured to heat the plurality of filaments into a molten solution. The disclosure additionally includes a mixing chamber attached adjacent the heating chamber and comprising a plurality of spinning sharp blades configured to homogenize a heat transfer from the heating chamber in the molten solution. The disclosure further includes an extruder neck adjacent the mixing chamber of a predetermined length and a diameter according to design parameters for the 3D printing. The disclosure yet includes an extruder and pump adjacent the extruder neck and configured to extrude the molten solution according to the 3D printing device requirements.

### BRIEF DESCRIPTION OF THE DRAWINGS

FIG. 1 is a front perspective view of the high temperature 3D printing device in accordance with an embodiment of the present disclosure.

FIG. 2 is a cross sectional view X of the 3D printing device in accordance with an embodiment of the present disclosure.

FIG. 3 is a cross sectional view Y of the 3D printing device in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

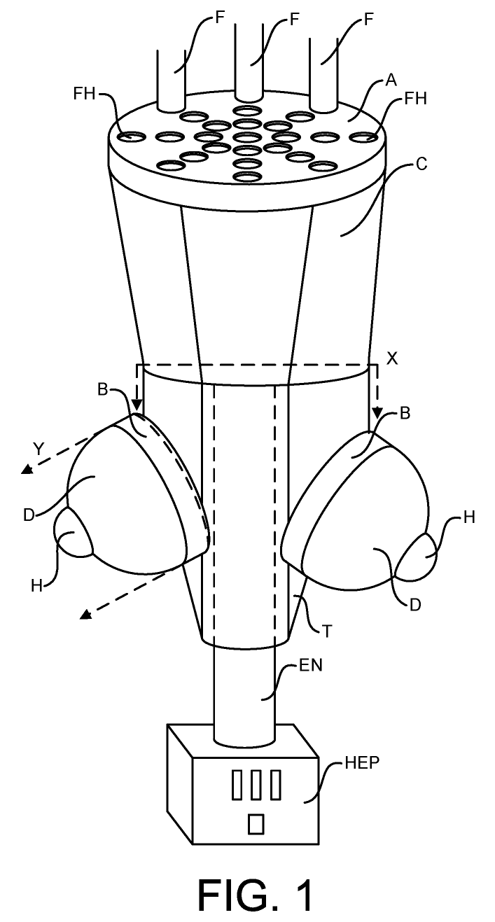

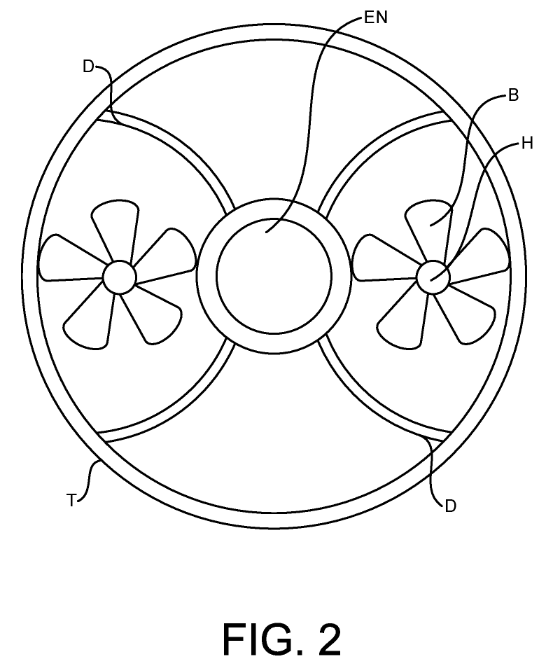

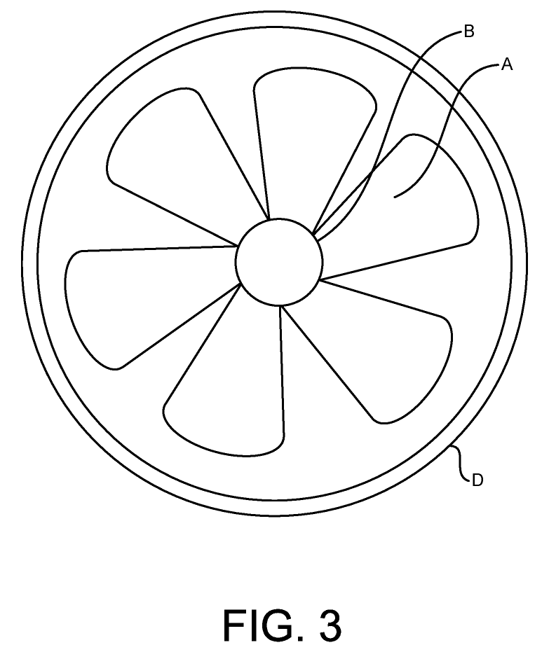

FIG. 1 is a front perspective view of the high temperature 3D printing device showing: filaments referenced as F, filament holes FH, filament sieve referenced as A, heating chamber C, Domes D, mixing chamber T, sharp blades referenced as B, hubs H for spinning sharp blades B, an extruder neck EN and an extruder and pump HEP in accordance with an embodiment of the present disclosure. A cross section X is illustrated in FIG. 2 and a cross section Y is illustrated in FIG. 3 below. The heating chamber C is therefore external to all other component parts and therefore achieves a ultra high temperature for generating a molten solution from the filaments F entering the heating chamber. The spinning blades B are therefore able to mix and chop filaments of various and discrete melting points and achieve a homogenous molten solution there from. The pump at the extruder is optional to a gravity feed and a mechanical feed of a filament having a melting point above an inside temperature of the melting chamber as a ramrod. An angle of rotation of the spinning and sharp blades B allows chopping, mixing and blending of the molten solution external to the melting chamber and facilitates a movement of the molten solution there through to the extruder independent of the pump there at.

FIG. 2 is a cross sectional illustration of the spinning blades in the mixing chamber according to an embodiment of the present disclosure. The mixing chamber T, the spinning blades B, the extruder neck EN, hub B and housing domes D are shown.

FIG. 3 is a cross section illustration of the spinning blades B inside the dome in accordance with an embodiment of the present disclosure. The domes D house the spinning blades B which are sharpened for cutting any unmelted filaments for a homogenous molten solution there from. The hub H provides a point of rotation there around. The dome D provides a recirculation of the molten solution into and there from for a mixing of various melted filaments. A typical angle of rotation of the spinning and cutting blades is a 45 degree relation to a flow of the molten solution there through.

The present disclosed high temperature 3D printing device, also known as “The Umbrella”, offers a modern accessory that allows users to achieve extreme temperatures, limited only by the metal/material being used and/or the power available to generate heat, as they perform 3D printing tasks. The Umbrella introduces a novel FDM 3D Printer that requires no electronics, PCV boards, or electrical components inside the hot chamber, except for the heater hot end wire, which is insulated with thermal nichrome accessories. All components of the Umbrella are mounted outside the chamber, providing a unique advantage over traditional designs and it employs a motor mounted on the device which effectively turns everything along the axis. This revolutionary 3D printer allows users to achieve extreme temperatures without risk of overheating the motor or affecting the flow of electronic equipment, ensuring consistent and accurate printing every time. This innovative, top-quality printer may benefit all individuals who seek to print advanced materials, whether for prototyping or production.

Super high temperature FDM 3d printer using low heat such as PLA (polylactic acid) filaments use pt 50 watt heater for the hot end. For high temperature, a nichrome wrap is used around the hot end. Filaments such as carbon fiber, nylon 12, peek, etc. require a temperature above 500 degrees and employ a magnetism induction for filaments including aluminum, copper, titanium, inconel , stainless steel, steel etc. Induction magnetism machines are used to tweak the wire hot end.

The extruder neck of the disclosed 3d printing device and machine is unique because it does not need to have any electronics, pcb boards, or electrical components inside the hot melting chamber except the heater hot end wire which can be insulated with thermal accessory. All the components are mounted outside the chamber. Additionally, the magnetic induction and filament extruder are long, motor or pump is mounted outside the melting chamber. Instead of square or rectangle box, the disclosed melting chamber is octagon 8 size shaped. Frame instead of bar shaped, the disclosed mixing chamber is triangle or funnel shaped. Three triangle pole connects to each other with triangle supports bars. The only wire is hot end inside chamber. Sensors and three ball bearings and triangle rail mount on frame.

The way the extruder mounts includes a nema 17 motor on the back. It drives a shoulder gear havng teeth for either timing belt drive or chain drive. At each end of the shoulder gear is connected a timing belt from the top first shoulder gear to the bottom second shoulder gear and repeated until the end of the neck. This neck extruder moves in all directions but can be limited to left and right so a rotating device is added in embodiments. The rotation device is either mounted on the top or back. A motor is mounted on the device which turns every thing along an axis. On the melting and mixing chamber end, the extruder, heat sink, water cooler, and hot end components are mounted. A separate housing for pcb motherboard and all electronics is included in embodiments. Also, a filament housing contains many, even a 100 types of filament or a different sized housing hold specific amounts of filament.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A 3D printing device comprising:
a filament sieve defining a plurality of openings for filaments to enter there through and provide a barrier to an egress of filaments there through; a heating chamber attached adjacent the filament sieve and configured to heat the plurality of filaments into a molten solution;
a mixing chamber attached adjacent the heating chamber and comprising a plurality of spinning sharp blades configured to homogenize a heat transfer from the heating chamber in the molten solution;
an extruder neck adjacent the mixing chamber of a predetermined length and a diameter according to design parameters for the 3D printing; and
an extruder adjacent the extruder neck and configured to extrude the molten solution according to the 3D printing device.

2. The 3D printing device of claim 1, wherein the filament sieve resembles a colander.

3. The 3D printing device of claim 1, wherein the heating chamber comprises an octogonal cross section.

4. The 3D printing device of claim 1, wherein the heating chamber is disposed external to the mixing chamber and the filament sieve.

5. The 3D printing device of claim 1, wherein the plurality of spinning sharp blades comprise cutting edges to blend filaments having a higher melting point relative to filaments having a plastic melting point.

6. The 3D printing device of claim 1, wherein the mixing chamber comprises a funnel shape having a larger end adjacent the heating chamber.

7. The 3D printing device of claim 1, wherein the mixing chamber comprises a funnel shape having a smaller end adjacent the extruder neck.

8. The 3D printing device of claim 1, wherein the predetermined length and diameter is determined by a cooling viscosity of the molten solution passing there through.

9. The 3D printing device of claim 1, wherein the plurality of spinning sharp blades comprise 2 sets of blades configured to spin about a central hub.

10. The 3D printing device of claim 1, wherein the plurality of spinning sharp blades are set to spin in a plane in an angular relation to a flow of the molten solution through the mixing chamber.

11. The 3D printing device of claim 1, wherein the heating chamber is heated by a hot wire having an electrical resistance proportional to a heat content thereof.

12. The 3D printing device of claim 1, wherein the heating chamber is heated by a superheated air passed through the heating chamber.

13. The 3D printing device of claim 1, wherein the heating chamber is heated by an infrared electromagnetic wave incident on the heating chamber.

14. The 3D printing device of claim 1, wherein the plurality of openings in the heating chamber are configured to receive a variety of filaments of plastic and semi plastic composition.

15. The 3D printing device of claim 1, wherein the filament sieve, the mixing chamber, the extruder neck and the extruder are all external to the mixing chamber.

16. The 3D printing device of claim 1, further comprising a mechanical feed of the molten solution through the device by a motorized pump attached thereto.
